(19) United States
(12) Patent Application Publication
(10) Pub. No.: US 2008/0137985 A1
(43) Pub. Date: Jun. 12, 2008

(54) Method, apparatus and system providing column shading correction for image sensor arrays

(76) Inventor: Alexander Mokhnatyuk, South Pasadena, CA (US)

Correspondence Address: DICKSTEIN SHAPIRO LLP, 1825 EYE STREET, NW, WASHINGTON, DC, 20006, US

(21) Appl. No.: 11/635,679

(22) Filed: Dec. 8, 2006

(51) Int. Cl. G06K 9/40

(52) U.S. Cl. 382/274

(57) ABSTRACT

A method of column shading correction comprising measuring pixel response values in a pixel array, calculating column shading correction coefficients for each column in a pixel array based on the steps of calculating a column noise correction coefficient value using dark rows and averaging a plurality of the column noise correction coefficients to produce a column shading correction coefficient for each column, adjusting the pixel response values based on the column shading correction coefficients, and applying column shading correction to the pixel array.

### FIELD OF THE INVENTION

Embodiments of the invention relate to column shading correction in an image sensor array.

### BACKGROUND OF THE INVENTION

Conventional imagers, especially those which exhibit fixed pattern column noise such as CMOS imagers, may employ column noise correction techniques. These techniques use dark rows and dedicated memory to correct column noise for individual columns.

In low light conditions, or when an image is particularly dark, however, conventional column noise correction techniques can actually contribute to column noise. Applying the column noise correction algorithm to a frame that does not exhibit column noise can introduce other noise, referred to as induction noise, because column noise correction coefficients were not calculated accurately enough.

Column shading is another problem associated with some images due to the optics used to acquire an image. Column shading is not corrected by conventional column noise correction techniques, which correct noise on a pixel by pixel basis. Column shading can also be exacerbated by the introduction of column noise caused by application of column noise correction in low light conditions.

FIG. 10 illustrates a pixel readout and processing system which may implement column noise reduction processing. A pixel array 1000 includes an image array area 1001 (labeled readout rows) for capturing an image and a dark row array area 1001′ having additional pixels for receiving non-image data; the received non-image data may be used for correction of image pixel data and other applications. The dark pixel rows 1001′ are read out and processed by dark row processing circuitry 1002, while the image array rows 1001 are read out by readout circuitry 1003 and processed by column correction circuitry 1004 using dark row data obtained from dark row processing circuitry 1002 to correct pixel data from imager array rows 1001. FIG. 10 also illustrates a sequential access memory (SAM) 1005, microprocessor unit (MPU) 1007 and circuitry 1006 for performing other processing on image pixel signal data obtained from readout circuitry 1003.

FIG. 1A illustrates an image capture portion of a conventional pixel array 100 having a plurality of rows 101-107 and columns 111-117. These rows and columns are part of the readout rows 1001 shown in FIG. 10. A conventional column noise correction technique may be applied by column correction circuitry 1004 (FIG. 10), which is located above image capture rows 101-107 of FIG. 1A, to the captured pixel signals of the individual pixels of column 111. One conventional column noise correction technique employs between 4 and 64 dark rows 1001′ (FIG. 10) for calculating one correction coefficient per column per color. As the array 100 reads out, the column coefficients for a given column, obtained from the dark row pixels of the column, may be used to correct the output of the pixels in each column 111-117 using known techniques, for example as described in U.S. Patent Publication No. 2006/0262210, hereby incorporated by reference.

As shown in FIGS. 1A, 1B and 1C, the pixel column correction algorithm is applied to the captured pixel signals of the individual pixels of respective columns 111 (FIG. 1A), 112 (FIG. 1B) and 113 (FIG. 1C). As discussed above, these conventional column noise correction techniques do not correct for column shading. A simplified method, apparatus and system for effecting column shading correction is desired.

### BRIEF DESCRIPTION OF THE DRAWINGS

FIG. 1A is an illustration of a conventional column noise correction technique being performed on a pixel array;

FIG. 1B is an illustration of the pixel array of FIG. 1A at a subsequent step in the column noise correction technique;

FIG. 1C is an illustration of the pixel array of FIG. 1B at a subsequent step in the column noise correction technique;

FIG. 2A is an illustration of a column shading correction technique being performed on a pixel array according to an embodiment of the invention;

FIG. 2B is an illustration of the pixel array of FIG. 2A at a subsequent step in the column shading correction technique;

FIG. 2C is an illustration of the pixel array of FIG. 2B at a subsequent step in the column shading correction technique;

FIG. 3A is an illustration of a column shading correction technique being performed on a pixel array according to another embodiment of the invention;

FIG. 3B is an illustration of the pixel array of FIG. 3A at a subsequent step in the column shading correction technique;

FIG. 3C is an illustration of the pixel array of FIG. 3B at a subsequent step in the column shading correction technique;

FIG. 4A is an illustration of a column shading correction technique being performed on a pixel array according to another embodiment of the invention;

FIG. 4B is an illustration of the pixel array of FIG. 4A at a subsequent step in the column shading correction technique;

FIG. 4C is an illustration of the pixel array of FIG. 4B at a subsequent step in the column shading correction technique;

FIG. 5A is an illustration of a column shading correction technique being performed on a pixel array according to another embodiment of the invention;

FIG. 5B is an illustration of the pixel array of FIG. 5A at a subsequent step in the column shading correction technique;

FIG. 5C is an illustration of the pixel array of FIG. 5B at a subsequent step in the column shading correction technique;

FIG. 6A is an illustration of a column shading correction technique being performed on a pixel array according to another embodiment of the invention;

FIG. 6B is an illustration of the pixel array of FIG. 6A at a subsequent step in the column shading correction technique;

FIG. 6C is an illustration of the pixel array of FIG. 6B at a subsequent step in the column shading correction technique;

FIG. 7A is an illustration of a column shading correction technique being performed on another portion of the pixel array according to the example illustrated in FIG. 6A-6C;

FIG. 7B is an illustration of the pixel array of FIG. 7A at a subsequent step in the column shading correction technique;

FIG. 7C is an illustration of the pixel array of FIG. 7B at a subsequent step in the column shading correction technique;

FIG. 8 is an illustration of a portion of a CMOS imager employing a pixel array employing a column shading correction technique according to an embodiment of the invention;

FIG. 9 illustrates a computer system having an imager employing a pixel array employing a column shading correction technique according to an embodiment of the invention; and

FIG. 10 illustrates of an example imager employing the column correction algorithm.

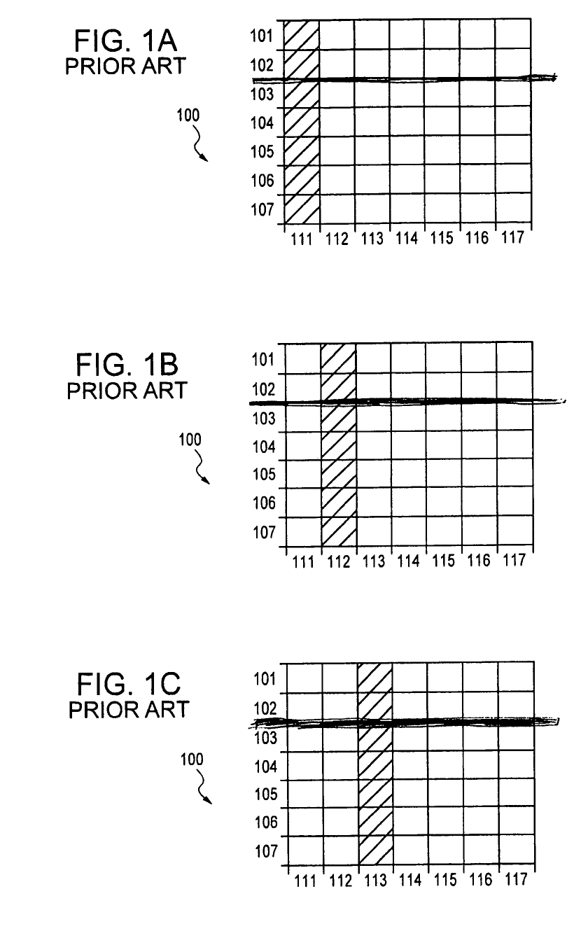

### DETAILED DESCRIPTION OF THE INVENTION

Disclosed embodiments use a column noise correction algorithm to correct column shading artifacts of an image, but without the introduction of induction noise. Disclosed embodiments also provide an option to switch between column noise correction and column shading correction. This is especially useful for different modes of pixel array operation. For example, in full resolution mode, where column noise is typically not seen, and where column noise correction requires a large amount of row memory to store column correction coefficients for each column, column shading correction is preferable to column noise correction because column shading correction requires less row memory. On the other hand, in a so-called “binning mode,” when pixel signals are combined to create a larger pixel, the size of the image is smaller, but the contribution of column noise is larger. Therefore, column noise correction is preferable to column shading correction in this instance.

In dark and low light images, column shading must often be suppressed to produce a good image quality. Column shading differs from column noise in that column noise tends to affect the pixel signals, e.g., individual columns of an array, while column shading affects pixel signals of multiple adjacent columns, or in some cases, the entire image array.

As discussed above, conventional column noise correction techniques can actually introduce column noise into an image when performed on frames where noise levels are already low. However, when an average of column noise correction coefficient values of a plurality of adjacent columns are applied to a column, column shading is reduced, producing a smoother image, and the column noise may be averaged out and reduced overall. Inaccuracies and other variances in individual column noise coefficients, such as inaccuracies due to the contribution of induction noise, are less problematic when using these column noise coefficients in the correction of column shading; because a plurality of calculated column noise correction coefficients are aggregated, these inaccuracies and variances are diminished.

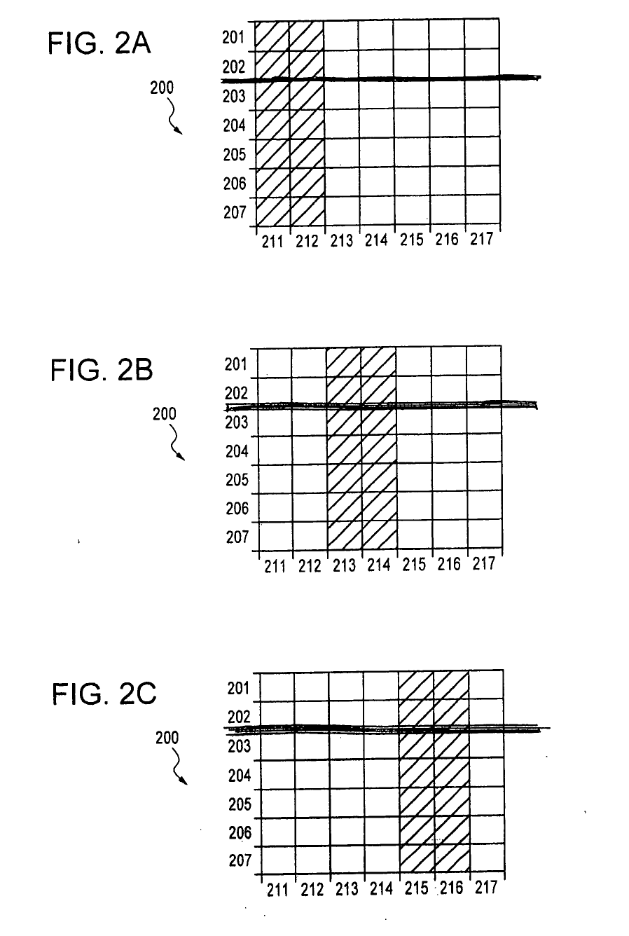

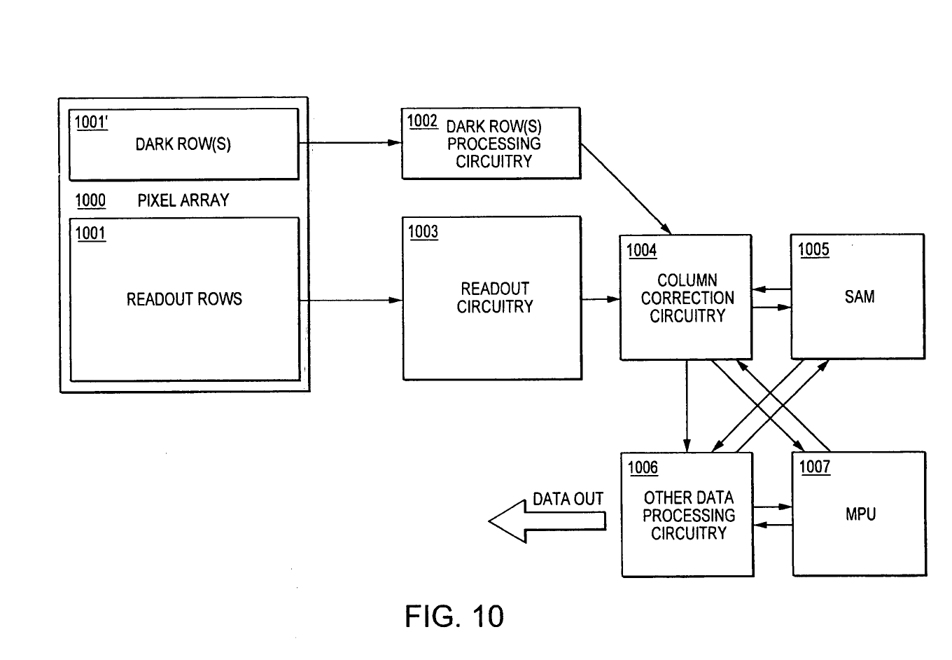

FIG. 2A illustrates a portion of an imager pixel array 200 in which column shading correction coefficients are applied to the array 200 according to an embodiment of the invention. FIG. 2A illustrates a portion of the pixel array 200 having a plurality of rows 201-207 and columns 211-217. For this embodiment, rows 201 and 202 are dark rows, and rows 203-207 are image rows; however, any number of dark rows may be used for calculation of column shading correction coefficients for any number of image rows. For this embodiment, first, the column noise correction coefficients are calculated for pixels in each dark row 201, 202 of columns 211 and 212 as described in U.S. Patent Publication No. 2006/0262210. The coefficients, typically between 8 and 16 bits long, may be calculated using column correction circuitry 1004 (FIG. 10) and may be stored in a sequential access memory (SAM) 1005 (FIG. 10) of the imager comprising array 200. The column noise correction coefficients of the dark rows 201, 202 in columns 211 and 212 are averaged by the column correction circuitry 1004 to obtain column shading correction coefficients for columns 211 and 212. The column shading correction coefficients are also typically between 8 and 16 bits long. The column shading correction coefficients are then applied to the image rows 203-207 of columns 211 and 212.

FIG. 2B is an illustration of the pixel array 200 of FIG. 2A at a subsequent step in the column shading correction technique. In FIG. 2B, the steps of the column shading correction coefficient calculation technique described above are performed on the dark rows 201-202 and image rows 203-207 of the next two columns 213, 214. As illustrated in FIG. 2C, the technique is then performed on the next two columns 215, 216 and so on until all image pixel signals of the array 200 (i.e., rows 203-207) have undergone pixel shading correction. An alternate technique for column correction comprises obtaining column noise correction coefficient values for all the pixels in the array before applying average values to subsets of the pixels.

In another embodiment, column shading correction coefficient calculation is performed on all columns of the dark rows 201-202, and is applied to some or all image pixel rows 203-207 of the pixel array 200 all at once. If the number of columns on the pixel array is larger than the total number of column shading correction coefficients stored in memory (row SAM), 2 adjacent column shading correction coefficients may be interpolated by the column correction circuit 1004 to produce one uniform column shading correction coefficient for a plurality of columns.

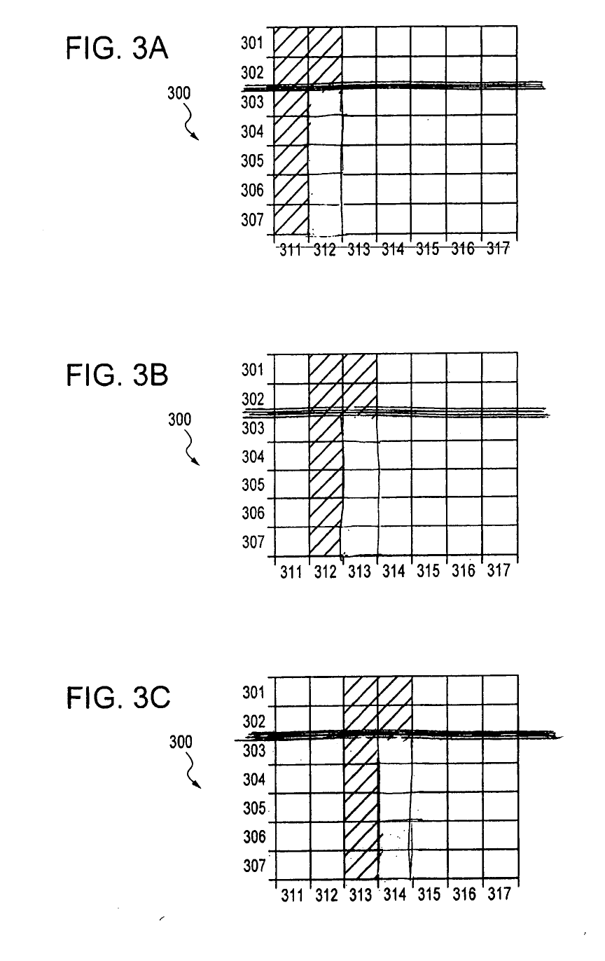

FIG. 3A illustrates a portion of an imager pixel array 300 in which column shading correction coefficients are applied to the array 300 according to another embodiment of the invention. FIG. 3A illustrates a portion of the pixel array 300 having a plurality of rows 301-307 and columns 311-317. For the column shading correction technique of this embodiment, first, the column noise correction coefficient calculation is performed for pixels in each dark row 301-302 of columns 311 and 312 to obtain column noise correction coefficient values for each pixel as described above. The same algorithm and hardware described above with reference to FIGS. 2A-2C may also be used in this and subsequent embodiments of the invention. Next, the column noise correction coefficient values are averaged and stored in sequential access memory 1005 as the column shading correction coefficient for column 311. In the illustrated embodiment, although the column shading correction coefficient for column 311 is calculated using data from dark pixel rows 301, 302 of columns 311 and 312, the calculated column shading correction coefficient is applied only to the image pixels (rows 303-307) of column 311 (the leftmost column of the two).

FIG. 3B is an illustration of the pixel array 300 of FIG. 3A at a subsequent step in the column shading correction technique. In FIG. 3B, the above-described steps of the technique are applied to the pixels of each dark row 301-302 of columns 312 and 313. If column noise correction coefficients for dark pixels have already been calculated and stored in sequential access memory 1005 in a previous step, these coefficients may be reused, e.g., the column noise coefficients calculated for the dark pixels of column 312 in FIG. 3A may be reused for the calculation of FIG. 3B. The average column noise correction value of each pair of pixels stored in sequential access memory 1005 as the column shading correction value for column 312 is applied to the image pixels (rows 303-307) of column 312 only. As illustrated in FIG. 3C, the column shading correction coefficient for the column 313 is calculated using the dark pixel data from columns 312 and 313, and is applied to the image pixels of column 313. The process is repeated sequentially until the image pixels of each column of the array 300 have undergone column shading correction.

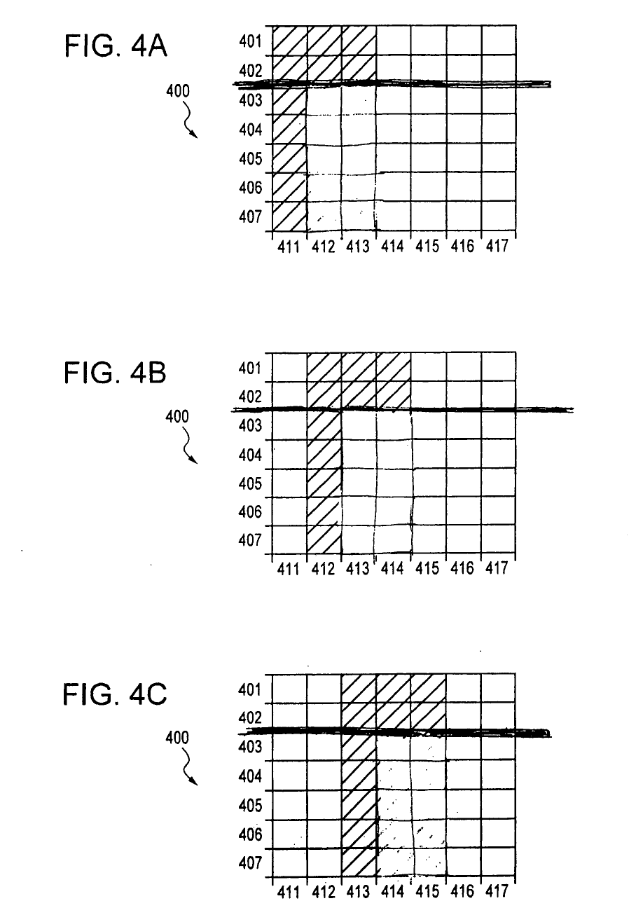

FIG. 4A illustrates a portion of an imager pixel array 400 in which column shading correction coefficients are applied to the array 400 according to another embodiment of the invention. FIG. 4A illustrates a portion of the pixel array 400 having a plurality-of dark rows 401-402, image rows 403-407 and columns 411-417. For this embodiment, column shading correction coefficients for each column are calculated using dark row data from that column and the 2 subsequent columns. As shown in FIG. 4A, the column noise correction value for column 411 is calculated using dark row data (rows 401, 402) of columns 411-413 in each dark row 401-402 to obtain column noise correction coefficient values for each pixel as described above. Next, the column noise correction coefficient values are averaged and stored in sequential access memory 1005, and in this embodiment, the average value is applied to the image pixels 403-407 in each row of column 411 (the leftmost column of the three) only.

FIG. 4B is an illustration of the pixel array 400 of FIG. 4A at a subsequent step in the application of column shading correction. In FIG. 4B, column noise correction coefficients are calculated for each dark row 401-402 of columns 412-414. The column noise correction coefficients are averaged to produce a column shading correction value for column 412, the leftmost column of the three. As illustrated in FIG. 4C, the technique is performed on columns 413-415 and on each sequential group of three adjacent columns until all image pixel signals of each column of the array 400 have been corrected.

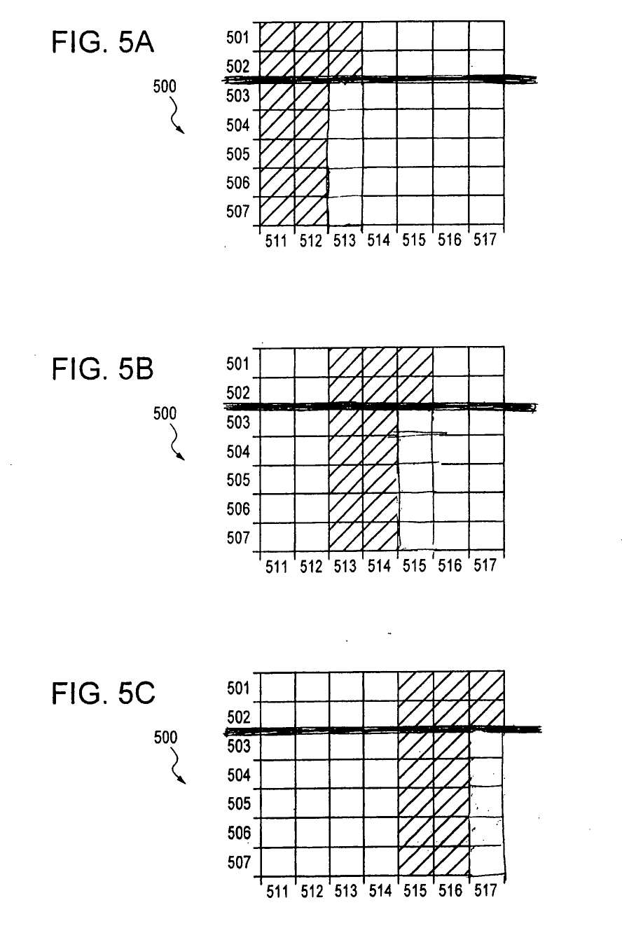

FIG. 5A illustrates a portion of an imager pixel array 500 in which column shading correction coefficients are applied to the array 500 according to another embodiment of the invention. FIG. 5A illustrates a portion of the pixel array 500 having a plurality of dark rows 501-502, image rows 503-507 and columns 511-517. For this embodiment, first, the column noise correction coefficients for pixels in each dark row 501-502 of columns 511-513 are calculated as described above. Next, the column noise correction coefficient values are averaged to produce the column shading correction coefficient for columns 511 and 512. In this embodiment, the column shading correction coefficient is applied to the image pixels (rows 503-507) in columns 511 and 512 (the leftmost and center columns) only.

FIG. 5B is an illustration of the pixel array 500 of FIG. 5A at a subsequent step in the column shading correction application. In FIG. 5B, column noise correction coefficients are calculated for each dark row 501-502 of columns 513-515 and are averaged to produce column shading correction values for columns 513 and 514. The average column shading correction coefficient is applied to the image pixels in both columns 513 and 514. As illustrated in FIG. 5C, a column shading correction coefficient is calculated for image columns 515-516 using dark row data from columns 515-517, and so on until all pixel signals of the array 500 have been corrected.

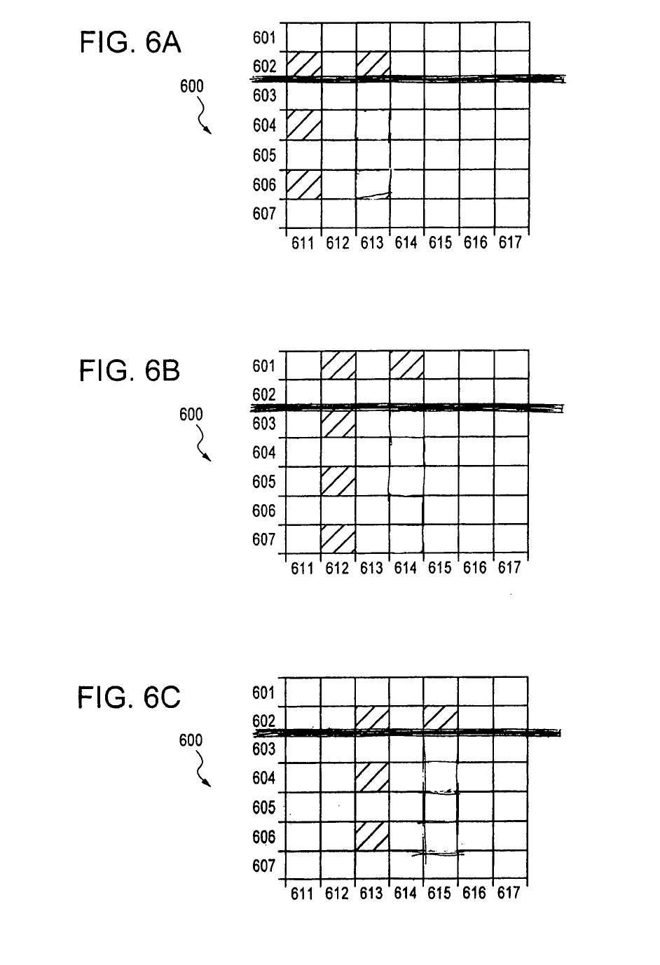

FIG. 6A illustrates a portion of an imager pixel array 600 in which column shading correction coefficients are applied to green pixels of the array 600 according to another embodiment of the invention. In this embodiment, color filters are arranged in a Bayer pattern over the array 600. Because pixel noise correction values may be different for different colored pixels, averaging the pixel noise correction values of directly adjacent pixels in a Bayer pattern may not produce an accurate pixel shading correction value. Therefore, only the pixel noise correction values of pixels having like colors are averaged. Because each column in a Bayer pattern comprises either alternating red and green or alternating blue and green pixels, there must be at least two dark rows 601-602 for this embodiment. In the illustrated example, column noise correction coefficients are calculated using dark pixel data from green pixels in columns 611 and 613 as described above; the coefficients are averaged to produce a column shading correction coefficient for the green pixels of column 611. For columns 611 and 613, green pixels are only present in dark row 602 and imager rows 604 and 606 following the Bayer pattern. Next, as shown in FIG. 6B, pixel noise correction values for green pixels in columns 612 and 614 are calculated and averaged to produce a column shading correction coefficient for the green pixels of column 612. For columns 612 and 614, green pixels are only present in dark row 601 and in imager rows 603, 605 and 607. FIG. 6C shows the next step, averaging pixel noise correction values for green pixels in columns 613 and 615 (dark row 602) to produce a column shading correction coefficient for the green pixels (imager rows 604 and 606) of column 613, and so on. This technique may use any combination of dark row data and apply the resultant column shading correction coefficients to any combination of image pixels, so long as the dark pixels and image pixels all measure the same color, in this case green.

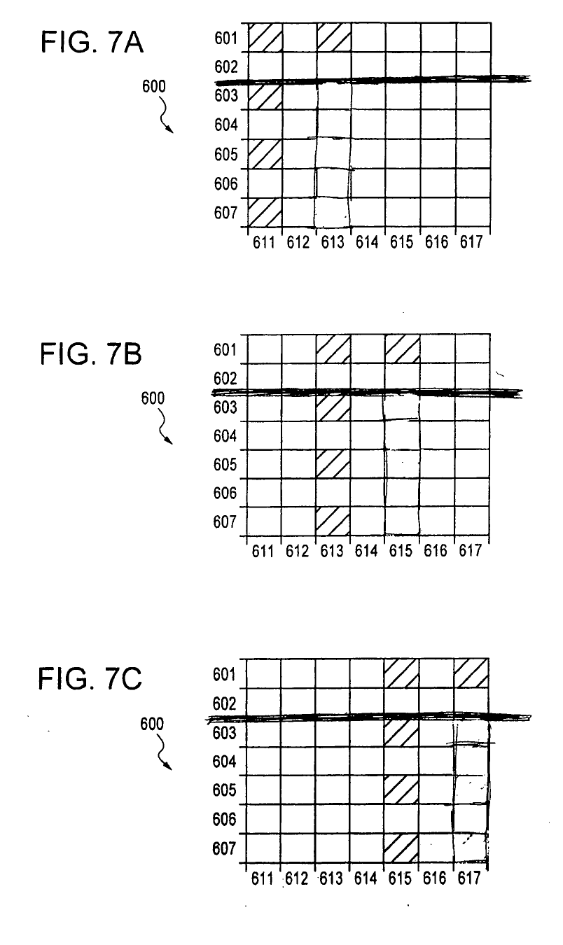

FIG. 7A illustrates a portion of an imager pixel array 600 of FIGS. 6A-6C in which column shading correction coefficients are applied to green pixels of the array 600. As discussed above, the color filters are arranged in a Bayer pattern. While green pixels are arranged in a checkerboard pattern, blue pixels are entirely absent from every other column and row. Therefore, although the step of acquiring a column shading correction coefficient from the column noise correction values for the blue pixels of the dark row (601) of columns 611 and 613, shown in FIG. 7A, is very similar to the step shown in FIG. 6A (for the green pixels in columns 611 and 613), since columns 612, 614, and 616 do not contain blue pixels, the second step, shown in FIG. 7B, ignores columns 612 and 614 and takes the average column noise correction coefficient value of columns 613 and 615 for rows having blue pixels (dark row 601 and imager rows 603, 605, and 607). The step of FIG. 7B averages the average column noise correction coefficient value of columns 615 and 617 for rows having blue pixels (dark row 601) to acquire the column shading correction coefficient for blue image pixels (rows 603, 605, and 607) of column 615. A similar technique may be used for red pixels, located in columns 612, 614 and 616 of dark row 602 and image rows 604 and 606.

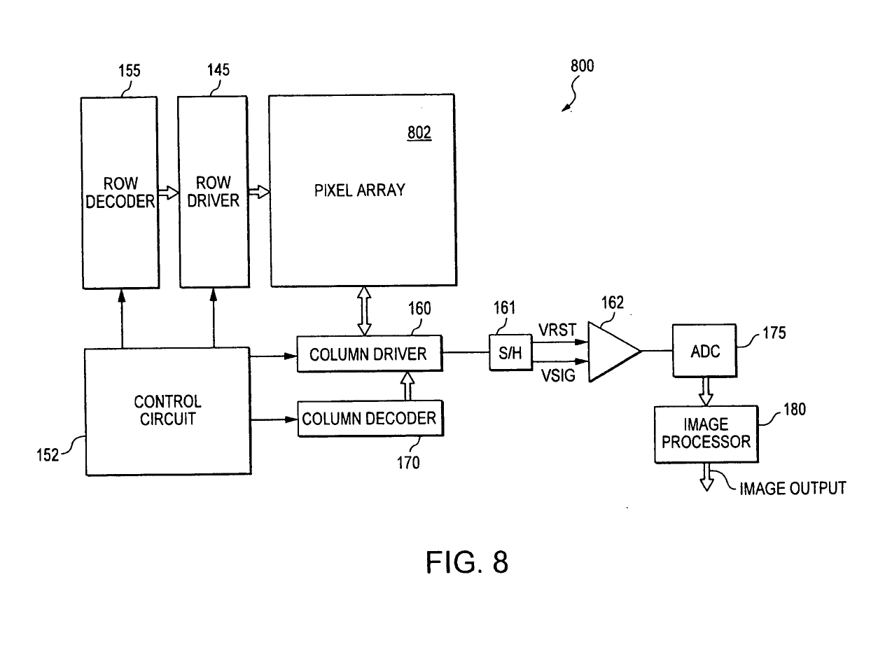

FIG. 8 illustrates a block diagram of a CMOS imager 800 constructed in accordance with at least one of the embodiments described above. The imager 800 contains a pixel array 802 and an image processor 180 that employs a column shading correction technique according to at least one of the embodiments shown in FIGS. 2A-7C. in this embodiment, the image processor 180 is analogous to and performs all the functions of column correction circuitry 1004, sequential access memory 1005, data processing circuitry 1006 and/or MPU 1007 of the embodiment shown in FIG. 10. Attached to the pixel array 802 is signal processing circuitry for controlling the pixel array 802. The pixel cells of each row in array 802 are all turned on at the same time by a row select line, and the pixel cells of each column are selectively output onto column output lines by respective column select lines. A plurality of row activation and column select lines are provided for the entire array 802. The row activation lines are selectively activated by a row driver 145 in response to row address decoder 155. The column select lines are selectively activated by a column driver 160 in response to column address decoder 170. Thus, a row and column address is provided for each pixel in the array 802.

The CMOS imager 800 is operated by a timing and control circuit 152, which controls address decoders 155, 170 for selecting the appropriate row and column lines for pixel readout. The control circuit 152 also controls the row and column driver circuitry 145, 160 such that they apply driving voltages to the drive transistors of the selected row and column lines. The pixel column signals, which typically include a pixel reset signal Vᵣₛₜ and a pixel image signal V_{sig}, are output to column driver 160, on column output lines, and are read by a sample and hold circuit 161. Vᵣₛₜ is read from a pixel cell immediately after the pixel cell's floating diffusion region is reset. V_{sig} represents the amount of charges generated by the photosensitive element of the pixel cell in response to applied light during an integration period. A differential signal (Vᵣₛₜ−V_{sig}) is produced by differential amplifier 162 for each readout pixel cell. The differential signal is digitized by an analog-to-digital converter 175 (ADC). The analog to digital converter 175 supplies the digitized pixel signals to an image processor 180, which forms and outputs a digital image. Although the illustrated imager in this embodiment is a CMOS imager, any imager employing a pixel array may be used.

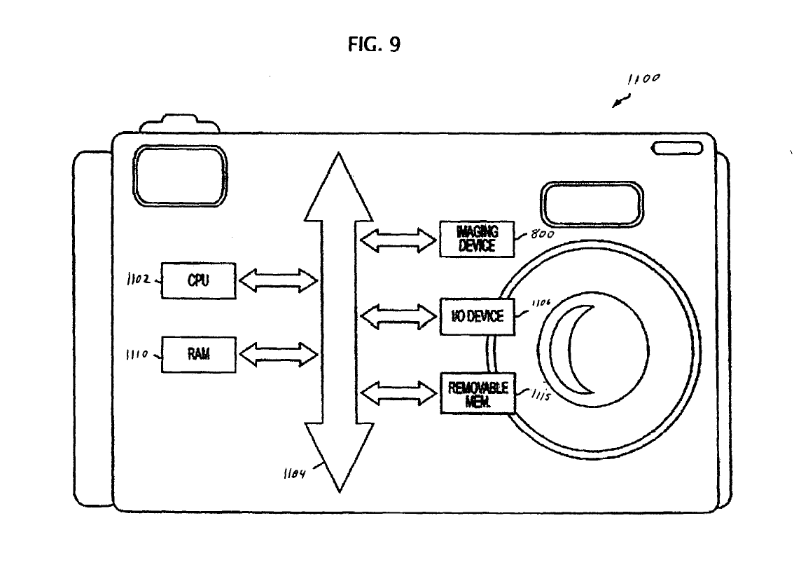

FIG. 9 illustrates a camera system 1100 that includes an imaging device, e.g., imager 800, constructed in accordance with an embodiment of the invention. As discussed above, the imager 800 contains a pixel array 802 and an image processor 180 that employs a column shading correction technique according to any embodiment or a combination of the embodiments shown in FIGS. 2A-7C. Alternatively, central processing unit 1102 may perform some or all steps of the column shading correction technique of any embodiment or a combination of the embodiments shown in FIGS. 2A-7C. The system 1100 is exemplary of a system having digital circuits that could include image sensor devices. The embodiments of the invention may also be employed in other systems besides camera system 1100; without being limiting, such a system could include a computer system, scanner, machine vision, vehicle navigation, video phone, surveillance system, auto focus system, star tracker system, motion detection system, image stabilization system, and other image sensing and/or processing system.

The camera system 1100 generally comprises a central processing unit (CPU) 1102, such as a microprocessor, that communicates with an input/output (I/O) device 1106 over a bus 1104. Imaging device 800 also communicates with the CPU 1102 over the bus 1104. The system 1100 also includes random access memory (RAM) 1110, and can include removable memory 1115, such as flash memory, which also communicates with CPU 1102 over the bus 1104. Imaging device 800 may be combined with a processor, such as a CPU, digital signal processor, or microprocessor, with or without memory storage on a single integrated circuit or on a different chip than the processor.

The above description and drawings are only to be considered illustrative of embodiments which achieve the features and advantages of the invention. Modification and substitutions to specific process conditions and structures can be made. Accordingly, the embodiments of the invention are not to be considered as being limited by the foregoing description and drawings, but is only limited by the scope of the appended claims.

What is claimed as new and desired to be protected by Letters Patent of the United States is:

1. A method of performing shading adjustment for an image, said method comprising:
calculating a column noise correction coefficient value for a first dark pixel;
calculating column noise correction coefficient values for at least one other dark pixel in the same row as the first dark pixel; and
using an average value of the column noise correction coefficient values of the first dark pixel and the at least one other dark pixel as a column shading correction value.

2. The method of claim 1, further comprising:
measuring a pixel response value in at least one designated pixel, the at least one designated pixel being in the same column as said first dark pixel; and
adjusting the pixel response value of said at least one designated pixel using the column shading correction value.

3. The method of claim 1, wherein the at least one other dark pixel is adjacent to the first dark pixel.

4. The method of claim 1, wherein the first dark pixel and the designated pixel are configured to measure the same color.

5. A method of performing shading adjustment for an image, said method comprising:
measuring a pixel response value in a designated pixel in an array, the array having a plurality of dark rows and a plurality of image rows, the designated pixel being in an image row;
calculating a column noise correction coefficient value for every pixel in the plurality of dark rows of the array, and
using an average value of the column noise correction coefficient values of the dark row pixels located in the same column as the designated pixel and at least one dark row pixel located in a column adjacent to the designated pixel as a column shading correction value; and
adjusting the pixel response value of the designated pixel responsive to the column shading correction value.

6. An image correction method comprising:
calculating a column noise correction coefficient value for a plurality of dark pixels in a pixel array, said pixel array having a plurality of dark rows containing the dark pixels, a plurality of image rows containing image pixels, and a plurality of columns, each pixel having a pixel response value;
calculating a column shading correction value for each respective pixel, said column shading correction value for each respective pixel comprising an average value of column noise correction coefficient values of at least one dark pixel within the same column as the respective pixel and column noise correction coefficient values for at least one dark pixel in another column; and
adjusting the pixel response value of each respective pixel responsive to the column shading correction value of each respective pixel.

7. An imager comprising:
an image processor configured to:
calculate a column noise correction coefficient value for a designated pixel;
calculate column noise correction coefficient values for at least one pixel in the same row as the designated pixel; and
set an average value of the column noise correction coefficient values of the designated pixel and the at least one other pixel as a column shading correction value.

8. The imager of claim 7, wherein said processor is further configured to:
measure a pixel response value in at least one image pixel located in the same column as the designated pixel; and
adjust the pixel response value of the image pixel responsive to the column shading correction value of the designated pixel.

9. The imager of claim 7, wherein the at least one other pixel is adjacent to the designated pixel.

10. The imager of claim 7, wherein the at least one other pixel and the designated pixel are configured to measure the same color.

11. The imager of claim 10, further comprising the act of outputting an image responsive to the adjusted pixel response values of the at least one image pixel.

12. The imager of claim 10, wherein each at least one other pixel is within a designated number of columns of the respective pixel.

13. The imager of claim 10, wherein the designated pixel and the at least one other pixel are configured to capture the same color.

14. The imager of claim 13, wherein the at least one image pixel and the designated pixel are configured to capture the same color.

15. The imager of claim 13, wherein the pixel array is arranged in the array in a Bayer color pattern.

16. The imager of claim 13 wherein the respective pixel and the at least one other pixel have at least one pixel interposed therebetween.
